(19) United States
(12) Patent Application Publication
(10) Pub. No.: US 2026/0148200 A1
(43) Pub. Date: May 28, 2026

(54) SERVICE PROVISION SYSTEM AND SERVICE PROVISION DEVICE

(71) Applicant: HONDA MOTOR CO., LTD., Tokyo (JP)

(72) Inventor: Ayano Kamiyama, Tokyo (JP)

(21) Appl. No.: 19/366,759

(22) Filed: Oct. 23, 2025

(30) Foreign Application Priority Data
Nov. 22, 2024 (JP) 2024-204112

(51) Int. Cl. G06Q 10/20

(52) U.S. Cl. CPC G06Q 10/20

(57) ABSTRACT

A service provision system includes: an equipment information acquisition unit that acquires equipment information relevant to equipment provided in a vehicle; an abnormality confirmation unit that confirms whether or not an abnormality has occurred in the equipment, based on the equipment information; a service decision unit that decides, from a plurality of services for coping with the abnormality, the service corresponding to the abnormality confirmed by the abnormality confirmation unit; and a service provision unit that provides the service decided by the service decision unit, to an occupant of the vehicle.

### INCORPORATION BY REFERENCE

The present application claims priority under 35 U.S.C. § 119 to Japanese Patent Application No. 2024-204112 filed on Nov. 22, 2024. The content of the application is incorporated herein by reference in its entirety.

### BACKGROUND OF THE INVENTION

### Field of the Invention

The present invention relates to a service provision system and a service provision device.

### Description of the Related Art

Conventionally, there is known a service in which a process for coping with an abnormality is performed to equipment of a vehicle. For example, Japanese Patent Laid-Open No. 2019-086841 discloses a technology for a movable body rescue system in which a first movable body sends a help signal to a server together with information about the current position in the case of shortage of electricity and the server receives current positions from a plurality of other second movable bodies and selects an electricity-supply movable body that performs electricity supply to the first movable body, from the plurality of the second movable bodies.

### SUMMARY OF THE INVENTION

In the conventional technology, there is a problem in that an occupant needs to determine and use an appropriate service for performing the process for the abnormality and it is difficult for the occupant to select an appropriate service.

The present invention has been made in view of the above-described circumstance, and has an object to allow the occupant to easily receive an appropriate service in the case where the abnormality has occurred in the vehicle.

Furthermore, the present invention has an object to enhance the manipulativeness of the service, for solving the above problem. Moreover, the present invention further improves the safety of traffic and contributes to the development of a sustainable transportation system.

An aspect of the present invention is a service provision system including: an equipment information acquisition unit that acquires equipment information relevant to equipment provided in a vehicle; an abnormality confirmation unit that confirms whether or not an abnormality has occurred in the equipment, based on the equipment information; a service decision unit that decides, from a plurality of services for coping with the abnormality, the service corresponding to the abnormality confirmed by the abnormality confirmation unit; and a service provision unit that provides the service decided by the service decision unit, to an occupant of the vehicle.

Another aspect of the present invention is a service provision device including: an equipment information acquisition unit that acquires equipment information relevant to equipment provided in a vehicle; an abnormality confirmation unit that confirms whether or not an abnormality has occurred in the equipment, based on the equipment information; a service decision unit that decides, from a plurality of services for coping with the abnormality, the service corresponding to the abnormality confirmed by the abnormality confirmation unit; and a service provision unit that provides the service decided by the service decision unit, to an occupant of the vehicle.

With the aspects of the present invention, in the case where the abnormality has occurred in the vehicle, the occupant can easily receive an appropriate service.

### BRIEF DESCRIPTION OF THE DRAWINGS

FIG. 1 is a diagram showing the configuration of a service provision system;

FIG. 2 is a diagram showing the configuration of a control system of a vehicle;

FIG. 3 is a flowchart showing an operation of a control device of the vehicle;

FIG. 4 is a flowchart showing an operation of the control device of the vehicle;

FIG. 5 is a diagram showing an exemplary screen that shows provision information;

FIG. 6 is a flowchart showing an operation of the control device of the vehicle;

FIG. 7 is a diagram showing an exemplary screen that is displayed when an abnormality has occurred in a drive source; and

FIG. 8 is a diagram showing an exemplary screen for performing manual transmission.

### DETAILED DESCRIPTION OF THE INVENTION

### 1. Configuration

A first embodiment will be described with reference to the drawings.

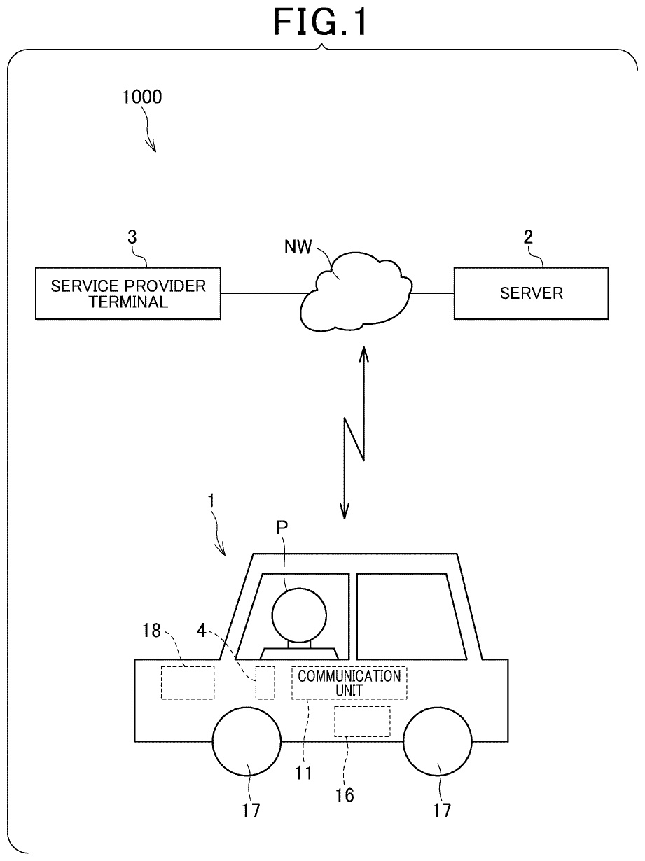

FIG. 1 is a diagram showing the configuration of a service provision system 1000 according to the first embodiment.

The service provision system 1000 is a system that provides services to a vehicle 1. The services that are provided by the service provision system 1000 include exchange of information with a service provider that actually performs a so-called road service and exchange of information with the fire department or the police.

As shown in FIG. 1, the service provision system 1000 includes the vehicle 1, a server 2, and a service provider terminal 3. Each of the server 2 and the service provider terminal 3 is an example of an “exterior”.

First, the server 2 will be described. The server 2 is a server device that manages a service plan subscribed for the vehicle 1. The service plan subscribed for the vehicle 1 is a list of services available in the vehicle 1. The procedure for subscription of the service plan may be performed by an occupant P that is a possessor of the vehicle 1, or may be performed by a car rental agent that rents the vehicle 1.

The server 2 is connected to a network NW, and communicates with the vehicle 1. Note that the network NW is a communication network that is constituted by public line networks, exclusive lines, other communication circuits, and the like. The service provision system 1000 may include the server 2 for each kind of the service plan subscribed for the vehicle 1.

The service provider terminal 3 is a terminal device that is used by a service provider with which the vehicle 1 communicates when a service is provided to the occupant P.

A portable terminal 4 carried in by the occupant P of the vehicle 1 may be included in the service provision system 1000. The portable terminal 4 is a PC (Personal Computer) that can communicate with the vehicle 1 and the network NW, as exemplified by a smartphone and a tablet terminal. The portable terminal 4 is an example of a “communication unit”.

The vehicle 1 shown as an example in FIG. 1 is a four-wheel vehicle. The vehicle 1 is an electric vehicle.

The vehicle 1 is provided with multiple kinds of equipment. As the equipment, the vehicle 1 includes a drive source 16, tire units 17, and a car battery unit 18. In addition, as the equipment, the vehicle 1 is provided with a windshield wiper, a headlight, an inter-vehicle distance measurement apparatus, a shock sensor, and others, although not illustrated. The equipment of the vehicle 1 can be changed when appropriate, depending on the kind of the vehicle 1.

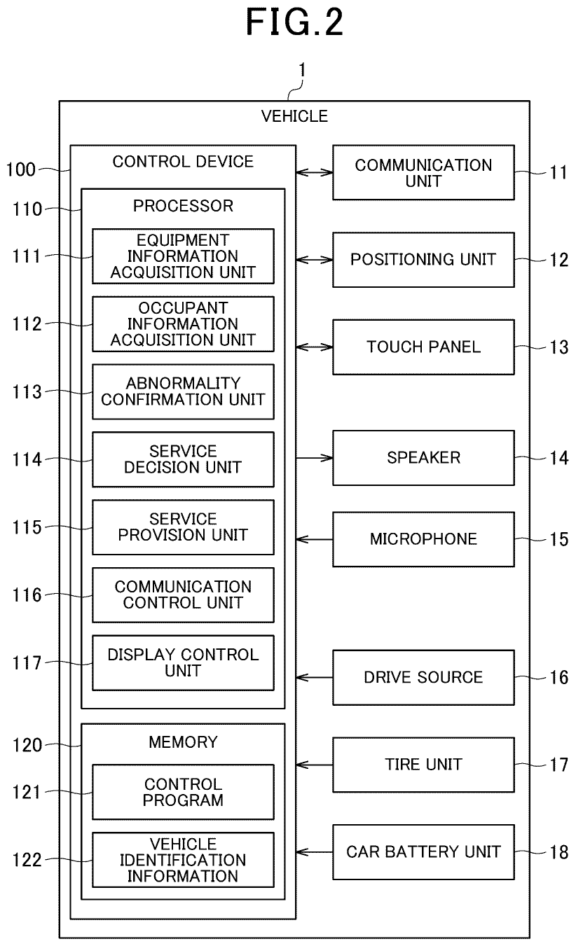

Next, the configuration of the vehicle 1 will be described with reference to FIG. 2.

FIG. 2 is a diagram showing the configuration of a control system of a control device 100 of the vehicle 1. The control device 100 is an example of the “service provision device”.

The control device 100 included in the vehicle 1 is connected to a communication unit 11, a positioning unit 12, a touch panel 13, a speaker 14, a microphone 15, the drive source 16, the tire unit 17, and the car battery unit 18. Note that devices that are connected to the control device 100 are not limited to the above devices, and other kinds of devices may be connected.

The communication unit 11 is a communication device that includes a transmitter and a receiver, and performs wireless communication in conformity with a communication standard for the service provision system 1000. For example, the communication unit 11 is a TCU (Telematics Control Unit). Note that as the communication unit, the vehicle 1 may separately include a communication unit that communicates with the portable terminal 4 and a communication unit that communicates with a device other than the portable terminal 4.

The positioning unit 12 measures the current position of the vehicle 1 by receiving signals from GPS (Global Positioning System) satellites. Note that the positioning unit 12 may be configured to receive signals from GNSS (Global Navigation Satellite System) satellites, instead of GPS satellites.

The touch panel 13 displays a variety of information and displays software buttons for accepting inputs from the occupant P, in accordance with the control from a display control unit 117 of the control device 100.

The speaker 14 outputs a variety of sound, in accordance with the control from the control device 100.

The microphone 15 collects sound, in accordance with the control from the control device 100.

The control device 100 includes a processor 110 such as a CPU (Central Processing Unit) and an MPU (Micro Processor Unit), a memory 120, and an interface circuit for connecting other devices and sensors.

The memory 120 is a storage device that stores programs and data. The memory 120 stores a control program 121, vehicle identification information 122, and data that is processed by the processor 110. The memory 120 includes a non-volatile storage region. Further, the memory 120 may include a volatile storage region, and may configure a work area for the processor 110. For example, the memory 120 is constituted by a ROM (Read Only Memory) and a RAM (Random Access Memory).

The vehicle identification information 122 is identification information that is used in order that the server 2 uniquely identifies the vehicle 1 when a later-described occupant information acquisition unit 112 acquires occupant information from the server 2.

The control program 121 is a program that causes the processor 110 to function as functional units. The processor 110 reads and executes the control program 121 stored in the memory 120, and thereby, functions as an equipment information acquisition unit 111, the occupant information acquisition unit 112, an abnormality confirmation unit 113, a service decision unit 114, a service provision unit 115, a communication control unit 116, and the display control unit 117.

The display control unit 117 is an example of a “display unit”.

The equipment information acquisition unit 111 acquires equipment information about all target equipment of the equipment provided in the vehicle 1.

Examples of the target equipment include the drive source 16, the tire unit 17, the car battery unit 18, the positioning unit 12, and the communication unit 11.

The equipment information acquisition unit 111 acquires, as the equipment information, output values of a sensor, in the case where the sensor is included in the equipment, and a signal that is generated when controlling the operation of the equipment.

As for the drive source 16, since the vehicle 1 is an electric vehicle, SOC (State Of Charge) of a traveling battery, and the like, corresponds to the equipment information. Note that in the case where the vehicle 1 is a gasoline vehicle, remaining gasoline amount and the like corresponds to the equipment information about the drive source 16. Further, the SOC of the traveling battery, the remaining gasoline amount of the gasoline vehicle, and the like may be detected by the drive source 16, or may be calculated by another processing unit.

As for the tire unit 17, output values of a pneumatic sensor that detects the pneumatic pressure of a tire included in the tire unit 17 corresponds to the equipment information.

As for the car battery unit 18, the output values of battery sensors that detect the charge-discharge current, voltage, and temperature of a car battery included in the car battery unit 18 corresponds to the equipment information. Note that the car battery is equipment that supplies electric power to an engine start unit, lamps such as the headlight, and other units provided in the vehicle 1.

Further, equipment information about specific equipment includes presence or absence of the specific equipment and operability or inoperability of the specific equipment. The specific equipment is a device of the above equipment that is particularly necessary for the provision of the service by the service provision system 1000.

For example, in the case where the information about the current position of the vehicle 1 is necessary for the provision of the service, the positioning unit 12 is the specific equipment. Further, for example, in the case where the communication with the service provider terminal 3 is necessary for the provision of the service, the communication unit 11 is the specific equipment.

In the embodiment, the specific equipment includes the positioning unit 12, the communication unit 11, the speaker 14, and the microphone 15.

Further, the specific equipment may include the touch panel 13.

The specific equipment information indicating presence or absence of the specific equipment is information indicating whether the positioning unit 12 or communication unit 11, the speaker 14, and the microphone 15 are previously provided in the vehicle 1.

The specific equipment information indicating operability or inoperability of the specific equipment is information indicating whether the operations of the positioning unit 12 or communication unit 11, the speaker 14, and the microphone 15 are possible.

The case where the operation of the positioning unit 12 is impossible is a case where the positioning unit 12 is broken down, as exemplified by a case where signals from GPS satellites cannot be received. The case where the operation of the communication unit 11 is impossible is a case where the receiver included in the communication unit 11 is broken down and the communication unit 11 cannot receive signals, for example.

The occupant information acquisition unit 112 acquires the occupant information about the vehicle 1 as follows.

The occupant information acquisition unit 112 causes the communication control unit 116 to execute communication, and thereby, sends an acquisition request signal including the vehicle identification information 122, to the server 2 connected to the network NW. The acquisition request signal is a signal for requesting the server 2 to send the occupant information corresponding to the vehicle identification information 122. The server 2 stores sets of the vehicle identification information 122 and the occupant information, and when the acquisition request signal is received, sends a signal including the occupant information corresponding to the vehicle identification information 122 in the received acquisition request signal, to the vehicle 1. Then, the occupant information acquisition unit 112 acquires the occupant information, by receiving the signal including the occupant information from the server 2 through the communication control unit 116. The occupant information is information indicating the list of the services included in the service plan subscribed for the vehicle 1. Further, the server 2 may send the occupant information to the vehicle 1 at the time of the update of the occupant information.

The abnormality confirmation unit 113 confirms whether or not the abnormality of the equipment has occurred, based on the equipment information acquired by the equipment information acquisition unit 111. When the abnormality of the equipment has been confirmed, the abnormality confirmation unit 113 generates abnormality information that includes a flag (or information or a signal) indicating that it is confirmed that there is the abnormality and information about the state of the abnormality, and that is associated with identification information about the equipment having the abnormality. For example, the identification information about the equipment is a previously determined name of the equipment.

In the case where the vehicle 1 is an electric vehicle, examples of the state of the abnormality of the drive source 16 include a state in which the SOC of the traveling battery included in the drive source 16 has decreased to such a level that the vehicle 1 cannot travel. In the case where the vehicle 1 is a gasoline vehicle, examples of the abnormality of the drive source 16 include shortage of gasoline.

Examples of the state of the abnormality of the tire unit 17 include the blowout or burst of the tire.

Examples of the state of the abnormality of the car battery unit 18 include the over-discharge of the car battery.

The service decision unit 114 selects a service that corresponds to the abnormality information and that is provided by the later-described service provision unit 115. The service corresponding to the abnormality information is a service for performing a process for coping with the abnormality of the equipment in which the abnormality has been confirmed.

The service decision unit 114 selects and decides a service for performing a process for the abnormality that corresponds to the abnormality information generated by the abnormality confirmation unit 113, based on the equipment information, the abnormality information, and the occupant information.

The selection of the service based on the occupant information and the abnormality information by the service decision unit 114 will be described.

The service decision unit 114 selects services decided to be available based on the occupant information.

Specifically, the service decision unit 114 selects services for performing the process for the abnormality that corresponds to the abnormality information. In this selection, the service decision unit 114 refers to the occupant information acquired from the server 2, and eliminates services that are not included in the list of the services in the subscribed service plan. That is, the service decision unit 114 selects services that are included in both of the list of the services corresponding to the abnormality information and the list of the services in the service plan.

In the case where no service for performing the process for the abnormality that corresponds to the abnormal information is included in the subscribed service plan, the service selected by the service decision unit 114 is not present. In this case, the service decision unit 114 does not decide the service that is provided by the service provision unit 115, and causes the communication control unit 116 and the display control unit 117 to execute a later-described service proposal process.

A method by which the service decision unit 114 decides the service that is provided by the service provision unit 115 based on the equipment information and the abnormality information will be described.

From services selected as the service in which the process for the abnormality that corresponds to the abnormality information is performed and that is based on the occupant information, the service decision unit 114 further decides a service for which the specific equipment necessary for the provision of the selected service is included in the vehicle 1 and can operate, and decides the selected service as the service that is provided by the service provision unit 115.

For example, in the case where services in which the process for the abnormality that corresponds to the abnormality information is performed and that are based on the occupant information are selected but it is confirmed from the equipment information that the positioning unit 12 does not operate, the service decision unit 114 selects, from the selected services, a service for which it is not necessary to send the information indicating the current position of the vehicle 1, as the service that is provided by the service provision unit 115. In this case, an example of a service that is not decided by the service decision unit 114 as the service that is provided by the service provision unit 115 is a service for which it is necessary to send the position information of the vehicle 1 to the exterior.

Further, for example, in the case where services in which the process for the abnormality that corresponds to the abnormality information is performed and that are based on the occupant information are selected but the it is confirmed from the equipment information that the communication unit 11 does not operate, the service decision unit 114 decides, from the selected services, a service for which the communication unit 11 is not necessary, as the service that is provided by the service provision unit 115. In this case, an example of a service that is not decided by the service decision unit 114 as the service that is provided by the service provision unit 115 is a service for which the occupant P of the vehicle 1 needs to call the service provider using the communication unit 11.

Further, also in the case where there is no service in which the process for the abnormality that corresponds to the abnormality information is performed and that is selected based on the occupant information and the equipment information, the service decision unit 114 does not decide the service that is provided by the service provision unit 115, and causes the communication control unit 116 and the display control unit 117 to execute the later-described service proposal process.

The service provision unit 115 provides the service decided by the service decision unit 114.

In the embodiment, the provision of the service is the exchange of information with the service provider. Specifically, the provision of the service includes the sending of at least one of the equipment information, the abnormality information, and the position information to the service provider terminal 3 that is used by the service provider or to the server 2, and the call with the service provider that uses the service provider terminal 3.

That is, the service provision unit 115 provides the service to the occupant P, by causing the communication control unit 116 to communicate with the service provider terminal 3 that is used by the service provider.

The communication control unit 116 communicates with the service provider terminal 3 and the server 2 through the communication unit 11 or the portable terminal 4.

The display control unit 117 displays a screen indicating information and software buttons through the touch panel 13. Note that the display control unit 117 may perform voice guidance through the speaker 14. Further, the display control unit 117 accepts inputs from the touch panel 13. The display control unit 117 may accept voice inputs through the microphone 15.

The service proposal process by the communication control unit 116 and the display control unit 117 will be described below.

The service proposal process is a process of providing information relevant to the service to the occupant P in the case where the service decision unit 114 cannot decide the service that is provided by the service provision unit 115.

In the service proposal process, in response to an instruction of the execution of the service proposal process from the service decision unit 114, the communication control unit 116 sends an information provision signal for requesting the server 2 to send, to the vehicle 1, provision information relevant to a service in which the process for the abnormality that corresponds to the abnormality information can be performed.

When the provision information is received from the server 2 in response to the information provision signal sent by the communication control unit 116, the display control unit 117 displays a screen that shows the provision information. The provision information includes the name and contact information of a service provider that can perform the process of the abnormality that corresponds to the abnormality information even when the service plan is not subscribed for the vehicle 1.

### 2. Operation

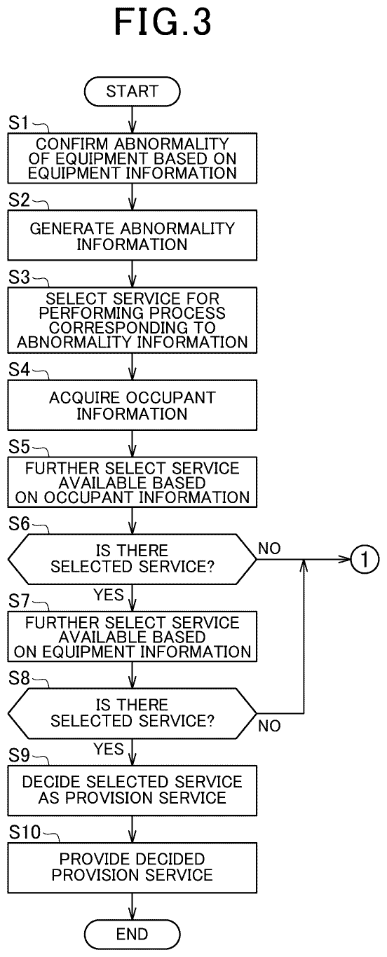

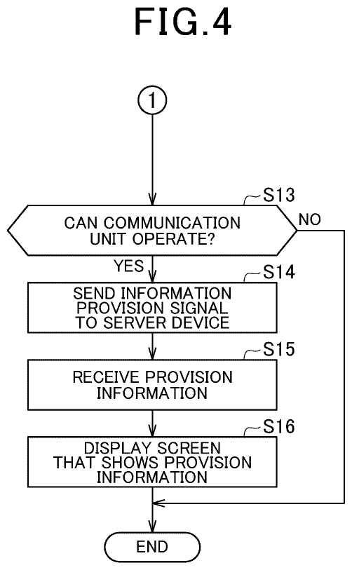

Next, the operation of the processor 110 of the control device 100 in the service provision system 1000 will be described with use of FIG. 3 and FIG. 4.

FIG. 3 and FIG. 4 are flowcharts showing the operation of the control device 100. The operation of the control device 100 when the abnormality of the equipment of the vehicle 1 is confirmed will be particularly described with use of FIG. 3 and FIG. 4.

In the flowchart shown in FIG. 3, the equipment information acquisition unit 111 acquires the equipment information from each equipment, and next, based on the acquired equipment information, the abnormality confirmation unit 113 repeats a sequence of operations for confirming whether the abnormality of the equipment has occurred, with a predetermined period. As described above, the equipment information acquired by the equipment information acquisition unit 111 includes also the specific equipment information.

In the case where the abnormality confirmation unit 113 does not confirm that the abnormality of the equipment has occurred, step S1 described below and other operations are not performed, and the acquisition of the equipment information by the equipment information acquisition unit 111 is repeated again with the predetermined period.

When it is confirmed that the abnormality of the equipment has occurred (step S1), the abnormality confirmation unit 113 generates the abnormality information corresponding to the equipment having the abnormality (step S2).

Next, the service decision unit 114 selects the service for performing the process that copes with the abnormality and that corresponds to the abnormality information (step S3).

Next, the occupant information acquisition unit 112 acquires the occupant information about the vehicle 1, from the server 2 (step S4).

Next, the service decision unit 114 further selects the service available based on the service plan that is subscribed for the vehicle 1 and that is indicated by the occupant information (step S5).

Next, the service decision unit 114 determines whether or not there is the service selected in the selection in steps S3 and S5 (step S6).

In the case where there is the selected service (step S6: YES), the service decision unit 114 further selects the service available based on the equipment information (step S7).

Specifically, in the case where the specific equipment necessary for the provision of the service selected in step S5 can operate based on the specific equipment information included in the acquired equipment information, the service decision unit 114 selects the service because of being available. In the case where the specific equipment cannot operate, the service decision unit 114 does not select the service because of being unavailable.

Next, the service decision unit 114 determines whether or not there is the service selected in selection in step S7 (step S8).

In the case where there is the selected service (step S8: YES), the service decision unit 114 decides the selected service as the service that is provided by the service provision unit 115 (step S9).

Next, the service provision unit 115 provides the decided service to the occupant P (step S10).

Specifically, the service provision unit 115 provides the decided service to the occupant P, by causing the communication control unit 116 to communicate. In the case where the decided service requires the communication with the service provider terminal 3, which of the communication unit 11 and the portable terminal 4 is used by the communication control unit 116 for communication is previously determined.

For example, in the case where the abnormality information generated in step S2 indicates an abnormal state that leads to the determination that the vehicle 1 met with an accident, an automatic report to the police, the emergency department, or the like is executed in step S10.

Next, the flowchart in FIG. 4 will be described. The flowchart in FIG. 4 shows an example of the service proposal process.

In the case where there is not the service selected in steps S3 and S5 (step S6: NO) or in the case where there is not the service selected in step S7 (step S8: NO), the service decision unit 114 determines whether the communication unit 11 can operate, based on the equipment information (step S13). In the case where the service decision unit 114 determines that the communication unit 11 cannot operate (step S13: NO), the processor 110 ends the operation. Alternatively, in the case where there is the provision information that is previously stored, the provision information may be displayed on a reading screen. Alternatively, information for prompting the registration of a telephone number of a new business operator may be displayed on a screen G1.

In the case where the service decision unit 114 determines that the communication unit 11 can operate (step S13: YES), the communication control unit 116 sends the information provision signal to the server 2 (step S14), and receives the provision information (step S15).

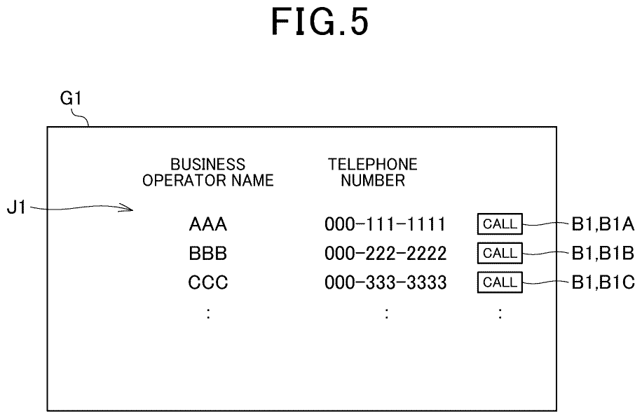

Next, the display control unit 117 displays the screen G1 (see FIG. 5) that shows provision information J1 (step S16).

FIG. 5 is a diagram showing an example of the screen G1 that shows the provision information J1. The screen G1 displays the names of business operators that can provide the service, and telephone numbers corresponding to the names of the business operators, as the provision information J1. Further, the screen G1 displays a call button B1 for executing call, for each business operator name and each telephone number. The call button B1 is a software button that includes a character string “CALL”. Further, the screen G1 may display the name of the business operator, the date and time of a past use, the telephone number, and a QR code (R) allowing call start.

When a call button B1A corresponding to a business operator name “AAA” is pushed, the communication control unit 116 calls a telephone number “000-111-1111” corresponding to the business operator name “AAA”. As for a call button B1B corresponding to a business operator name “BBB” and a call button B1C corresponding to a business operator name “CCC”, similarly, when the call button B1B or B1C is pushed, the communication control unit 116 calls the corresponding telephone number.

Note that in the case where the provision information J1 does not include the business operator that can provide the service, the screen G1 may display information for prompting the registration of a telephone number of a new business operator.

[2-1. Specific Example of Operation about Abnormality of Drive Source]

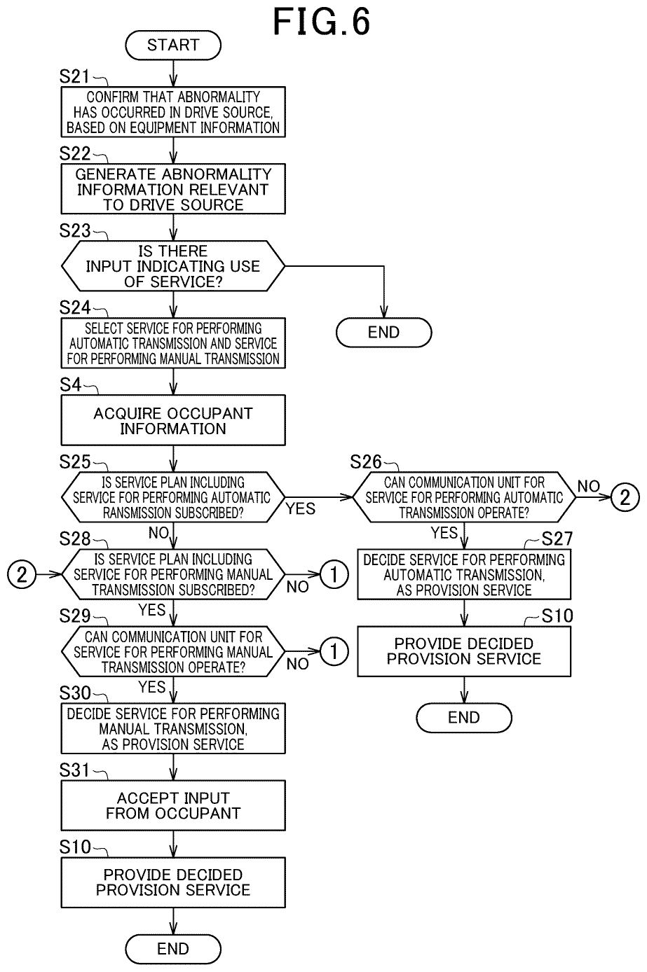

Next, with use of FIG. 6, a specific example of the operation of the control device 100 in the service provision system 1000 will be described with a focus of the abnormality of the drive source 16. Particularly, a case where the abnormality has occurred about the SOC of the traveling battery of the drive source 16 will be described below.

FIG. 6 is a flowchart showing the operation of the control device 100. The same operations as those in FIG. 3 are denoted by the same reference characters, and descriptions thereof are omitted when appropriate. Before the operation shown in FIG. 6, as in the description with FIG. 3, the equipment information acquisition unit 111 acquires the equipment information from each equipment, and next, based on the acquired equipment information, the abnormality confirmation unit 113 repeats a sequence of operations for confirming whether the abnormality of the equipment has occurred, with a predetermined period.

First, when it is confirmed that the abnormality of the traveling battery of the drive source 16 has occurred (step S21), the abnormality confirmation unit 113 generates the abnormality information relevant to the drive source 16 (step S22).

Next, the service decision unit 114 determines whether there is the instruction of the use of the service from the occupant P (step S23).

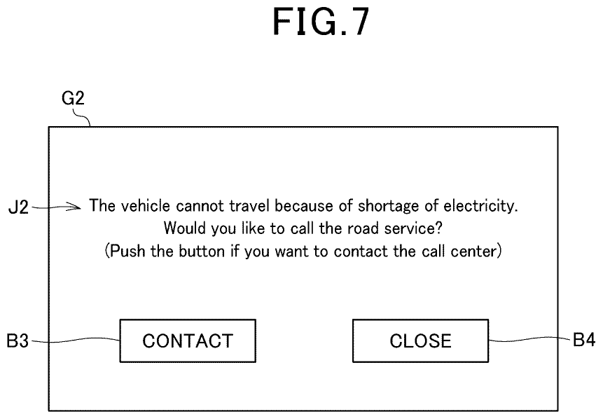

FIG. 7 is a diagram showing an example of a screen G2 that is displayed when the abnormality has occurred in the drive source 16. The screen G2 is a screen that is displayed on the touch panel 13 after step S22, and the occupant P can select whether or not to use the service, through the screen G2.

The screen G2 displays guidance information J2 that prompts the selection of whether or not to use the service, a contact button B3 that is a software button including a character string “CONTACT”, and a termination button B4 that is a software button including a character string “CLOSE”.

The guidance information J2 includes a character string “The vehicle cannot travel because of shortage of electricity. Would you like to call the road service? (Push the button if you want to contact the call center)”. The service decision unit 114 determines that there is the instruction of the use of the service from the occupant P, when the occupant P pushes the contact button B3, and determines that there is not the instruction of the use of the service from the occupant P, when the occupant P pushes the termination button B4 or pushes a spot other than the guidance information J2, or a predetermined time elapses from the display of the guidance information J2.

Back to the description of FIG. 6, in the case where the service decision unit 114 determines that there is not the instruction of the use of the service from the occupant P (step S23: NO), the operation ends. In this case, for example, the occupant P uses the portable terminal 4 carried by the occupant P, and searches and uses another service that is available from the portable terminal 4.

In the case where the service decision unit 114 determine that there is the instruction of the use of the service from the occupant P (step S23: YES), the service decision unit 114 selects a service for performing automatic transmission and a service for performing manual transmission, as a service allowing the execution of the process for the abnormality of the drive source 16, based on the abnormality information (step S24). The service for performing the automatic transmission is a service in which the transmission for call can be automatically performed to a service provider. The service for performing the manual transmission is a service in which the transmission for call can be performed by calling the service provider through the manual input of the telephone number of the service provider by the occupant P, or by manually calling the telephone number of the service provider that is previously stored in the memory 120.

Next, step S4 is executed, and thereafter, the service decision unit 114 determines whether or not a service plan including the service for performing the automatic transmission is subscribed for the vehicle 1, based on the occupant information (step S25).

In the case where the service plan including the service for performing the automatic transmission is subscribed for the vehicle 1 (step S25: YES), the service decision unit 114 determines whether or not the communication unit 11 that is used in the service for performing the automatic transmission can operate, based on the equipment information (step S26).

Next, in the case where the communication unit 11 can operate (step S26: YES), the service decision unit 114 decides the service for performing the automatic transmission, as the service that is provided by the service provision unit 115 (step S27). Next, the service provision unit 115 provides the decided service to the occupant P (step S10). In this way, in the service for performing the automatic transmission, the occupant P receives the service, simply by pushing the contact button B3 on the screen G2 shown in FIG. 7. In the case where the communication unit 11 cannot operate in step S26 (step S26: NO), it is determined whether or not a service plan including the service for performing the manual transmission is subscribed for the vehicle 1 (step S28).

Back to the description of step S25, in the case where the service plan including the service for performing the automatic transmission is not subscribed for the vehicle 1 (step S25: NO), the service decision unit 114 determines whether or not the service plan including the service for performing the manual transmission is subscribed for the vehicle 1 (step S28).

In the case where the service plan including the service for performing the manual transmission is subscribed for the vehicle 1 (step S28: YES), the service decision unit 114 determines whether or not the communication unit 11 that is used in the service for the manual transmission can operate or whether or not the communication unit 11 that is used in the service for the manual transmission is connected to the portable terminal 4 through a predetermined communication system (for example, Bluetooth (R), in-vehicle WiFi (R), wired connection with a USB (Universal Serial Bus), or the like), based on the equipment information (step S29).

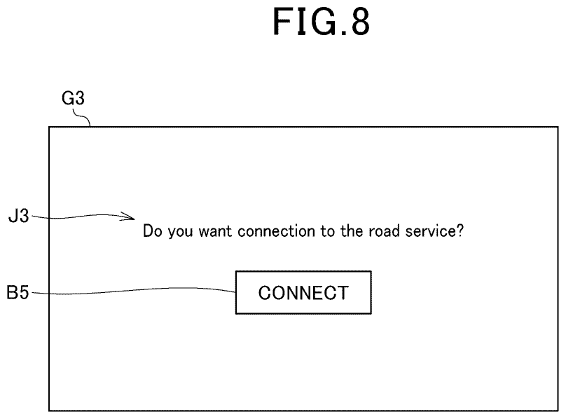

Next, in the case where the communication unit 11 can operate (step S29: YES), the service decision unit 114 decides the service for performing the manual transmission, as the service that is provided by the service provision unit 115 (step S29). Next, the display control unit 117 displays a screen G3 (see FIG. 8), and accepts the input of the instruction of the manual transmission from the occupant P, through the screen G3 (step S31).

FIG. 8 is a diagram showing an example of the screen G3 for performing the manual transmission. The screen G3 displays guidance information J3 that presents the provision of the service for performing the manual transmission, and a call button B5. The guidance information J3 includes a character string “Do you want connection to the road service?”. The call button B5 is a software button including a character string “CONNECT”, and when the call button B5 is pushed by the occupant P, the instruction of the manual transmission is given from the occupant P.

Back to the description of FIG. 6, after the finish of step S31, when the call button B3 is pushed, the service provision unit 115 provides the decided service to the occupant p (step S10).

As described above, the service for performing the automatic transmission, in which the work that is performed by the occupant P is smaller than in the service for performing the manual transmission, is preferentially selected, and therefore, a service that is more appropriate to the occupant P is provided. Consequently, the manipulativeness of the service is further enhanced.

In the case where the service plan including the service for performing the manual transmission is not subscribed for the vehicle 1 (step S28: NO) or in the case where the communication unit 11 cannot operate in step S29 (step S29: NO), the service decision unit 114 transitions to step S13 shown in FIG. 4, and executes the service proposal process. Further, in the case where the communication unit 11 cannot operate in step S29 (step S29: NO), the screen G3 in FIG. 8 may be displayed, but since the communication unit 11 cannot operate, the call button B5 is put into a state in which the selection is impossible (for example, a blackout state).

Note that the operation shown in FIG. 6 is particularly an operation for coping with the abnormality of the drive source 16, but can be replaced by an operation for coping with the abnormality of the tire unit 17, the abnormality of the car battery unit 18, or the abnormality of other equipment.

### 3. Effect

As described above, the service provision system 1000 in the embodiment includes the equipment information acquisition unit 111 that acquires the equipment information relevant to the equipment provided in the vehicle 1, the abnormality confirmation unit 113 that confirms whether or not the abnormality has occurred in the equipment, based on the equipment information, the service decision unit 114 that decides, from a plurality of services for coping with the abnormality, the service corresponding to the abnormality confirmed by the abnormality confirmation unit 113, and the service provision unit 115 that provides the service decided by the service decision unit 114, to the occupant of the vehicle.

In this configuration, when the abnormality of the equipment has occurred in the vehicle 1, the service decision unit 114 decides an appropriate service as the service that is provided by the service provision unit 115, and therefore, in the case where the abnormality has occurred in the vehicle 1, the occupant P can easily receive an appropriate service.

The service provision system 1000 includes the occupant information acquisition unit 112 that acquires the occupant information relevant to the occupant P, and the service decision unit 114 decides the service available to the occupant P, based on the occupant information.

In this configuration, when the abnormality of the equipment has occurred in the vehicle 1, a service that is suitable for the abnormality of the vehicle 1 and that is available based on the occupant information is selected and provided, and thereby, the occupant P can easily receive an appropriate service.

The service decision unit 114 decides a service based on the equipment information, from services decided to be available to the occupant P based on the occupant information, as the service that is provided by the service provision unit 115.

In this configuration, the service that is provided is selected, such that a service for which the necessary equipment is provided in the vehicle 1 and can operate is provided, and thereby, it is possible to more appropriately select the service that the occupant P can receive.

The equipment information indicates presence or absence of the equipment and operability or inoperability of the equipment, and the service decision unit 114 decides the service based on the equipment information, from the services decided to be available to the occupant P based on the occupant information, as the service that is provided by the service provision unit 115, in the case where the specific equipment necessary for providing the service is provided in the vehicle 1 and can operate.

In this configuration, the service that is provided is selected, such that a service for which the necessary specific equipment is provided in the vehicle 1 and can operate is provided, and thereby, it is possible to more appropriately select the service that the occupant P can receive.

The vehicle 1 includes the communication unit 11 that can communicate with the exterior and the display control unit 117 that displays information to the occupant P. In the case where there is no service that can be decided by the service decision unit 114, the communication unit 11 sends, to the exterior, the information provision signal for requesting the sending of the information about the service to the vehicle 1, and when the information about the service that corresponds to the information provision signal sent by the communication unit 11 is received, the display control unit 117 displays the received information about the service.

In this configuration, even when there is no service that is available based on the abnormality information and the occupant information about the vehicle 1, it is possible to provide an appropriate service to the occupant P, by requesting information provision to the server 2.

The vehicle 1 includes a plurality of the communication units 11 each of which can communicate with the exterior, the portable terminal 4, and the communication control unit 116 that performs the communication control of the communication units 11 and the portable terminal 4. In the case where the service decided by the service decision unit 114 requires the communication with the exterior, the communication control unit 116 performs the communication with the exterior, by a previously determined communication unit 11 or the portable terminal 4.

In this configuration, when the service is provided, the communication method for the communication with the service provider terminal 3 is controlled by a previously determined method, and thereby, it is possible to appropriately provide the service to the occupant P.

The control device 100 in the embodiment includes the equipment information acquisition unit 111 that acquires the equipment information relevant to the equipment provided in the vehicle 1, the abnormality confirmation unit 113 that confirms whether or not the abnormality has occurred in the equipment, based on the equipment information, the service decision unit 114 that decides a service corresponding to the abnormality confirmed by the abnormality confirmation unit 113, from a plurality of services for coping with the abnormality, and the service provision unit 115 that provides the service decided by the service decision unit 114, to the occupant of the vehicle.

This configuration exerts the same effect as the above-described effect.

### 4. Other Embodiment

The above-described embodiment shows merely one aspect, and any modification and application can be performed.

In the above-described embodiment, the vehicle 1 having four wheels has been shown as an example, but the number of wheels of the vehicle 1 is not limited to four.

In the above-described embodiment, the touch panel 13 has been shown as an example, but the touch panel 13 is an example of display means. Without being limited to the touch panel 13, a display that has no touch operation function and that can be operated through operation keys or the like may be adopted. Further, the touch panel 13 may be a display that is included in a car navigation system, or may be provided on a meter panel.

In the above-described embodiment, the communication unit 11 that is a TCU provided in the vehicle 1 has been described as an example of the communication unit, but without being limited to this, it is only necessary to be a communication device that performs wireless communication in conformity with the communication standard for the service provision system 1000. Further, for example, the vehicle 1 may include a wireless router that is connected to a cigarette socket power source, or a USB (Universal Serial Bus) stick type wireless router that is connected to a car navigation system.

In the above-described embodiment, when the abnormality of the equipment is confirmed, the abnormality confirmation unit 113 is configured to generate the abnormality information that includes the flag (or information or a signal) indicating that it is confirmed that there is the abnormality and the information about the state of the abnormality, and that is associated with the identification information about the equipment having the abnormality, but the present invention is not limited to this. For example, when the abnormality of the equipment is confirmed, the abnormality confirmation unit 113 may output information only indicating that it is confirmed that the corresponding equipment has the abnormality, to the service decision unit 114.

In the above-described embodiment, the service decision unit 114 is configured to select the service for performing the process for the abnormality that corresponds to the abnormality information generated by the abnormality confirmation unit 113, based on the equipment information, the abnormality information, and the occupant information, and to decide the selected service as the service that is provided by the service provision unit 115, but the present invention is not limited to this. For example, the service decision unit 114 may select and decide the service for performing the process for the abnormality that corresponds to the abnormality information generated by the abnormality confirmation unit 113, based on the abnormality information and the occupant information.

In the above-described embodiment, the occupant information acquisition unit 112 is configured to acquire the occupant information from the server 2, but the present invention is not limited to this. For example, the occupant information may be previously stored in the memory 120 of the control device 100, and the service decision unit 114 may be configured to refer to the stored occupant information. Further, the occupant information acquisition unit 112 acquires the occupant information when the abnormality has occurred in the equipment, in the above description, but may acquire the occupant information at the time of the start-up of the vehicle. Further, the provision information also may be acquired at the time of the start-up of the vehicle.

In the above-described embodiment, the drive source 16, the tire unit 17, and the car battery unit 18 that are provided in the vehicle 1 are connected to the control device 100 that is configured to confirm the abnormality of the equipment, but the present invention is not limited to this. Furthermore, a starter motor that is included in the vehicle 1 may be connected to the control device 100. In the starter motor, an output signal of an electric motor included in the starter motor corresponds to the equipment information, and examples of the abnormality of the starter motor include a state in which the electric motor included in the starter motor does not operate.

The processor 110 may be constituted by a plurality of processors, or may be constituted by a single processor. The processor 110 may be hardware that has such a program that the above-descried functional units are realized. In this case, the processors are constituted by an ASIC (Application Specific Integrated Circuit) or an FPGA (Field Programmable Gate Array), for example.

Further, the configuration of each unit of the vehicle 1 shown in FIG. 1 and FIG. 2 is an example, and the specific implementation manner is not particularly limited. That is, it is not always necessary to implement hardware that individually corresponds to a unit, and naturally, a single processor may execute programs, and thereby may realize the functions of the units. Further, some of functions that are realized by software in the above-described embodiment may be realized by hardware, and some of functions that are realized by hardware may be realized by software.

Further, step units of the operations shown in FIG. 3, FIG. 4, and FIG. 6 are step units into which the operations are divided depending on main processing contents, and the present invention is not limited by dividing ways and names of processing units. The operations may be divided into a larger number of step units, depending on processing contents. Further, the division may be performed such that a single step unit includes a larger number of processes. Further, the order of steps may be changed when appropriate, without departing from the spirit of the present invention.

### 4. Configurations Supported by Above Embodiment

The above embodiment supports the following configurations.

(Configuration 1) A service provision system comprising: an equipment information acquisition unit that acquires equipment information relevant to equipment provided in a vehicle; an abnormality confirmation unit that confirms whether or not an abnormality has occurred in the equipment, based on the equipment information; a service decision unit that decides, from a plurality of services for coping with the abnormality, the service corresponding to the abnormality confirmed by the abnormality confirmation unit; and a service provision unit that provides the service decided by the service decision unit, to an occupant of the vehicle.

In the service provision system in configuration 1, when the abnormality of the equipment has occurred in the vehicle, the service decision unit decides an appropriate service as the service that is provided by the service provision unit, and therefore, in the case where the abnormality has occurred in the vehicle, the occupant can easily receive an appropriate service.

(Configuration 2) The service provision system according to configuration 1, comprising an occupant information acquisition unit that acquires occupant information relevant to the occupant, wherein the service decision unit decides the services that are available to the occupant, based on the occupant information.

In the service provision system in configuration 2, when the abnormality of the equipment has occurred in the vehicle, a service that is suitable for the abnormality of the vehicle and that is available based on the occupant information is selected and provided, and thereby, the occupant can easily receive an appropriate service.

(Configuration 3) The service provision system according to configuration 2, wherein the service decision unit decides the service based on the equipment information, from the services decided to be available to the occupant based on the occupant information, as the service that is provided by the service provision unit.

In the service provision system in configuration 3, the service that is provided is selected, such that a service for which the necessary equipment is provided in the vehicle and can operate is provided, and thereby, it is possible to more appropriately select the service that the occupant can receive.

(Configuration 4) The service provision system according to configuration 3, wherein the equipment information indicates presence or absence of the equipment and operability or inoperability of the equipment, and the service decision unit decides the service based on the equipment information, from the services decided to be available to the occupant based on the occupant information, as the service that is provided by the service provision unit, when a specific kind of the equipment necessary for providing the service is provided in the vehicle and can operate.

In the service provision system in configuration 4, the service that is provided is selected, such that a service for which the necessary specific equipment is provided in the vehicle and can operate is provided, and thereby, it is possible to more appropriately select the service that the occupant can receive.

(Configuration 5) The service provision system according to any one of configuration 1 to 4, wherein the vehicle includes a communication unit that can communicate with an exterior and a display unit that displays information to the occupant, wherein when the service that can be decided by the service decision unit is not present, the communication unit sends an information provision signal to the exterior, the information provision signal being a signal for requesting sending of information about the service to the vehicle, and when information about the service that corresponds to the information provision signal sent by the communication unit is received, the display unit displays the received information about the service.

In the service provision system in configuration 5, even when there is no service that is available based on the abnormality information and the occupant information about the vehicle, it is possible to provide an appropriate service to the occupant, by requesting information provision to the exterior.

(Configuration 6) The service provision system according to any one of configurations 1 to 5, wherein the vehicle includes a plurality of communication units each of which can communicate with an exterior and a communication control unit that performs communication control of the communication units, wherein when the service decided by the service decision unit requires communication with the exterior, the communication control unit performs the communication with the exterior, by a previously determined communication unit of the plurality of communication units.

In the service provision system in configuration 6, when the service is provided, the communication method for the communication with the exterior is controlled by a previously determined method, and thereby, it is possible to appropriately provide the service to the occupant.

(Configuration 7) A service provision device comprising: an equipment information acquisition unit that acquires equipment information relevant to equipment provided in a vehicle; an abnormality confirmation unit that confirms whether or not an abnormality has occurred in the equipment, based on the equipment information; a service decision unit that decides, from a plurality of services for coping with the abnormality, the service corresponding to the abnormality confirmed by the abnormality confirmation unit; and a service provision unit that provides the service decided by the service decision unit, to an occupant of the vehicle.

The service provision device in configuration 7 exerts the same action and effect as configuration 1.

### Reference Signs List

1 . . . vehicle, 2 . . . server, 3 . . . service provider terminal, 4 . . . portable terminal (communication unit), 11 . . . communication unit, 12 . . . positioning unit, 13 . . . touch panel, 14 . . . speaker, 15 . . . microphone, 16 . . . drive source, 17 . . . tire unit, 18 . . . car battery unit, 100 . . . control device (service provision device), 110 . . . processor, 111 . . . equipment information acquisition unit, 112 . . . occupant information acquisition unit, 113 . . . abnormality confirmation unit, 114 . . . service decision unit, 115 . . . service provision unit, 116 . . . communication control unit, 117 . . . display control unit (display unit), 120 . . . memory, 121 . . . control program, 122 . . . vehicle identification information, 1000 . . . service provision system, NW . . . network, P . . . occupant

1. A service provision system comprising:
an equipment information acquisition unit that acquires equipment information relevant to equipment provided in a vehicle;
an abnormality confirmation unit that confirms whether or not an abnormality has occurred in the equipment, based on the equipment information;
a service decision unit that decides, from a plurality of services for coping with the abnormality, the service corresponding to the abnormality confirmed by the abnormality confirmation unit; and
a service provision unit that provides the service decided by the service decision unit, to an occupant of the vehicle.

2. The service provision system according to claim 1, comprising an occupant information acquisition unit that acquires occupant information relevant to the occupant, wherein
the service decision unit decides the services that are available to the occupant, based on the occupant information.

3. The service provision system according to claim 2, wherein
the service decision unit decides the service based on the equipment information, from the services decided to be available to the occupant based on the occupant information, as the service that is provided by the service provision unit.

4. The service provision system according to claim 3, wherein
the equipment information indicates presence or absence of the equipment and operability or inoperability of the equipment, and
the service decision unit decides the service based on the equipment information, from the services decided to be available to the occupant based on the occupant information, as the service that is provided by the service provision unit, when a specific kind of the equipment necessary for providing the service is provided in the vehicle and can operate.

5. The service provision system according to claim 1, wherein
the vehicle includes a communication unit that can communicate with an exterior and a display unit that displays information to the occupant, wherein when the service that can be decided by the service decision unit is not present,
the communication unit sends an information provision signal to the exterior, the information provision signal being a signal for requesting sending of information about the service to the vehicle, and
when information about the service that corresponds to the information provision signal sent by the communication unit is received,
the display unit displays the received information about the service.

6. The service provision system according to claim 1, wherein
the vehicle includes a plurality of communication units each of which can communicate with an exterior, and a communication control unit that performs communication control of the communication units, wherein
when the service decided by the service decision unit requires communication with the exterior,
the communication control unit performs the communication with the exterior, by a previously determined communication unit of the plurality of communication units.

7. A service provision device comprising:
an equipment information acquisition unit that acquires equipment information relevant to equipment provided in a vehicle;
an abnormality confirmation unit that confirms whether or not an abnormality has occurred in the equipment, based on the equipment information;
a service decision unit that decides, from a plurality of services for coping with the abnormality, the service corresponding to the abnormality confirmed by the abnormality confirmation unit; and
a service provision unit that provides the service decided by the service decision unit, to an occupant of the vehicle.
